(19) United States
(12) Patent Application Publication
(10) Pub. No.: US 2009/0066498 A1
(43) Pub. Date: Mar. 12, 2009

(54) TIRE LOCALIZATION SYSTEMS AND METHODS

(75) Inventors: Jakob Jongsma, Graz (AT); Axel Bialke, Ismaning (DE)

Correspondence Address: INFINEON TECHNOLOGIES AG;Patent Department, MUC 11.1.507, P.O. Box 221644, Munich, 80506, DE

(73) Assignee: INFINEON TECHNOLOGIES AG, Muenchen (DE)

(21) Appl. No.: 11/851,399

(22) Filed: Sep. 7, 2007

(51) Int. Cl. B60C 23/00

(52) U.S. Cl. 340/447

(57) ABSTRACT

Embodiments of the invention are related to tire localization. In one embodiment, a tire localization system comprises a wheel module and a control unit. The wheel module comprises a sensor, a global positioning system (GPS) receiver, and a radio frequency (RF) transmitter. The control unit is adapted to receive data from the sensor and the GPS receiver via the RF transmitter and determine a location of the wheel module relative to the control unit from at least a portion of the data.

### FIELD OF THE INVENTION

The invention generally relates to tire localization. More particularly, the invention relates to vehicle tire localization systems and methods utilizing satellite-based positioning systems, such as a global positioning system (GPS).

### BACKGROUND OF THE INVENTION

Tire pressure monitoring systems (TPMS) are used to monitor conditions within and surrounding vehicle tires. Parameters typically monitored include local temperature and pressure information, although systems may also monitor additional conditions such as tire and tread condition, velocity, and rotation, among others. Most TPMS comprise wheel-based sensors and other components that monitor and then transmit the local information via radio signals to a central receiver in another part of the vehicle. Power is supplied to the tire-based systems by local batteries, energy harvesters or scavengers, or other means.

As local information is sent from each tire to the central receiver, it is helpful to know which information originated from which particular wheel on the vehicle. This localization enables dashboard reporting of conditions in each individual tire and quick determination of the location of a condition or problem. Localization can be partial, such as distinguishing the two passenger side tires from the two driver side tires on a four-wheel vehicle, or full, such as identifying both the front or rear and driver or passenger position of each tire.

Several methods for partial and/or full localization are currently known. Some methods use additional hardware at each tire, such as receiver antennae or low frequency transmitters, which require additional cabling that increases the cost and complexity of the system. Other systems discriminate between wheel modules based on signal strength or temporal variations. These systems use a single receiver antenna, making reliable results difficult to obtain. Similar systems discriminate between wheel modules based on signal strength at two or more directional receiver antennae arranged centrally in the vehicle. The additional antenna, however, increases the cost and complexity of such systems. Still other systems detect the strength of a LF signal received at each wheel module from a central LF transmitter, although it is difficult in such systems to obtain reliable results. These and other systems may also increase power drain by requiring additional communications or activity by each wheel module. Increasing the power drain has the added disadvantage of reducing the overall system reliability in battery-powered systems.

While a goal of many of the aforementioned systems is to provide full localization, one example of a partial localization system determines the direction of rotation of a wheel from the phase difference of the component of gravity along two orthogonal accelerometer axes. This type of partial localization system can typically be implemented with a relatively low cost and good reliability when a two-axis accelerometer is integrated into each wheel module. The system, however, provides only partial localization by determining passenger/driver side but does not localize front/rear.

### SUMMARY OF THE INVENTION

Embodiments of the invention are related to tire localization. In one embodiment, a tire localization system comprises a wheel module and a control unit. The wheel module comprises a sensor, a global positioning system (GPS) receiver, and a radio frequency (RF) transmitter. The control unit is adapted to receive data from the sensor and the GPS receiver via the RF transmitter and determine a location of the wheel module relative to the control unit from at least a portion of the data.

The above summary of the invention is not intended to describe each illustrated embodiment or every implementation of the present invention. The figures and the detailed description that follow more particularly exemplify these embodiments.

### BRIEF DESCRIPTION OF THE DRAWINGS

The invention may be more completely understood from the following detailed description of various embodiments in connection with the accompanying drawings, in which:

FIG. 1 depicts a tire localization system according to an embodiment of the invention.

FIG. 2 depicts a wheel module according to an embodiment of the invention.

FIG. 3 depicts a tire localization system according to an embodiment of the invention.

FIG. 4 depicts a tire localization system according to an embodiment of the invention.

FIG. 5 depicts a tire localization system according to an embodiment of the invention.

FIG. 6 is a flowchart of a method according to an embodiment of the invention.

While the invention is amenable to various modifications and alternative forms, specifics thereof have been shown by way of example in the drawings and will be described in detail. It should be understood, however, that the intention is not to limit the invention to the particular embodiments described. On the contrary, the intention is to cover all modifications, equivalents, and alternatives falling within the spirit and scope of the invention as defined by the appended claims.

### DETAILED DESCRIPTION OF THE DRAWINGS

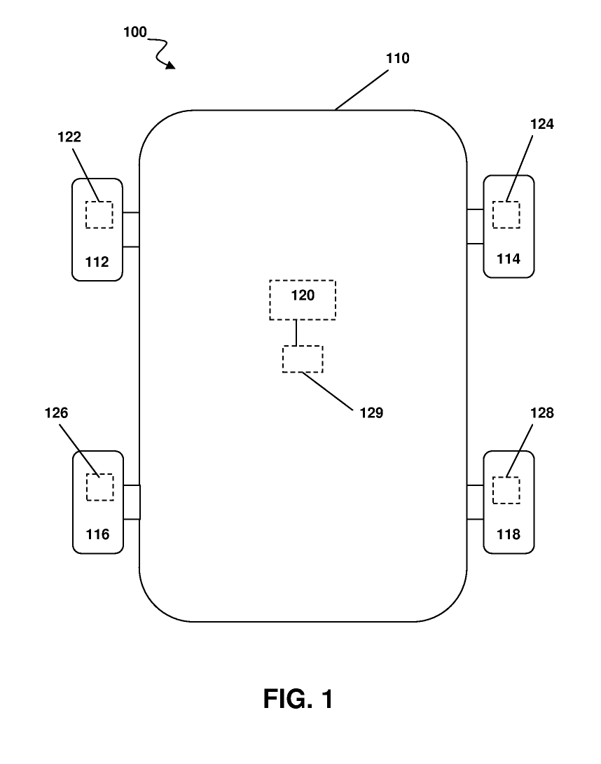

The invention is related to tire localization in tire pressure monitoring systems (TPMS), next-generation intelligent tire systems (ITS), and other systems related to the tires or wheels of a vehicle. Embodiments of systems and methods according to the invention can be implemented in various vehicles and utilize global or other satellite-based positioning systems. Various embodiments of the invention can reduce cost, complexity, and power drain while improving accuracy and reliability. The invention can be more readily understood by reference to FIGS. 1-6 and the following description. While the invention is not necessarily limited to the specifically depicted application(s), the invention will be better appreciated using a discussion of exemplary embodiments in specific contexts.

Referring to FIG. 1, a tire localization system (TLS) 100 according to an embodiment of the invention is depicted. TLS 100 is implemented in a vehicle 110, which can comprise an automobile, SUV, truck, semi-truck, bus, motorcycle, or other vehicle having two, four, or some other number of wheels and tires. Vehicle 110 is a four-wheel (112, 114, 116, 118) automobile and is but one example of a suitable vehicle for implementing an embodiment of TLS 100.

Typically, each wheel 112-118 comprises a tire including an inner liner that lines the inside of the tire, multiple ply layers over the inner liner, and one or more steel belts over the ply layers. A cushion layer and a base layer are situated over the steel belts and a cap layer, also referred to as the tread layer, is situated on the outside of the tire over the base layer. The tread interacts with the road surface to provide traction. The entire tire structure is then mounted on a rim coupled to an axle of the vehicle.

A wheel module 122, 124, 126, 128 is mounted at each wheel 112, 114, 116, 118, respectively, and is adapted to communicate with an electronic control unit (ECU) 120 mounted in vehicle 110. Each wheel module 122-128 comprises components to monitor one or more conditions local to each wheel 112-118 and exchange data and information with ECU 120. Wheel modules 122-128 can be mounted to the tire, the inner liner, and/or the rim, or to locations proximate wheels 112-118, such as the wheel housing, axle, or another location. The particular location each wheel module 122-128 is mounted in various embodiments can be selected based on the characteristics or conditions each wheel module 122-128 is configured to measure or observe. In various embodiment, one or more wheel modules 122-128 are related to anti-lock braking systems (ABS), electronic stability control (ESC), vehicle stability control (VSC), tire pressure monitoring (TPM), active steering, active suspension control, and other systems for which some or all relevant characteristics can be measured or observed at or near a wheel.

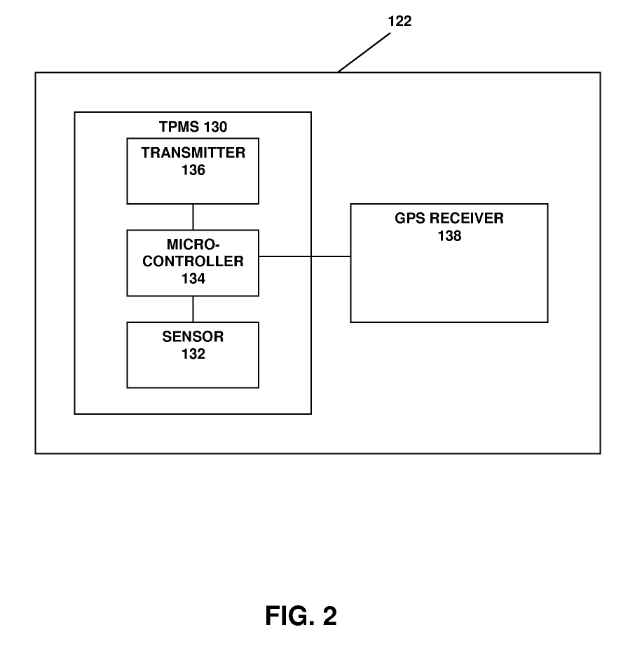

In an example embodiment to be described in more detail herein, wheel modules 122-128 comprise a tire pressure monitoring system (TPMS) mounted to the tire or inner liner to facilitate monitoring of tire pressure. Referring to FIG. 2, wheel module 122 comprises a TPMS 130. TPMS 130 comprises a sensor 132, such as an accelerometer, a microcontroller 134, and a transmitter 136, such as an RF transmitter. TPMS 130 further comprises a global positioning system (GPS) receiver 138. GPS receiver 138 is adapted to provide positioning, timing, and velocity information to microcontroller 134, which in turn is adapted to transmit the positioning information to ECU 120 via transmitter 136 in one embodiment. In other embodiments, GPS receiver 138 can comprise a receiver compatible with other satellite-based positioning systems, such as GLONASS and Galileo.

Each of wheel modules 124, 126, and 128 can comprise components similar to those depicted in FIG. 2 with respect to wheel module 122. Each wheel module 122-128 thus transmits sensor data and positioning, timing, and velocity information to ECU 120. ECU 120 is then adapted to localize each wheel 112-118 at least in part on the positioning information received. In one embodiment, this can be accomplished by comparing the received positioning information from each wheel module 122-128 with positioning information of vehicle 110. In such an embodiment, ECU 120 further comprises or is coupled to a vehicle GPS system 129 that determines positioning information for vehicle 110. In this embodiment as well as others, each wheel module 122-128 can be only intermittently active to reduce power consumption. Vehicle GPS system 129 can also be only intermittently active but has a high enough duty cycle to support communications with each wheel module 122-128.

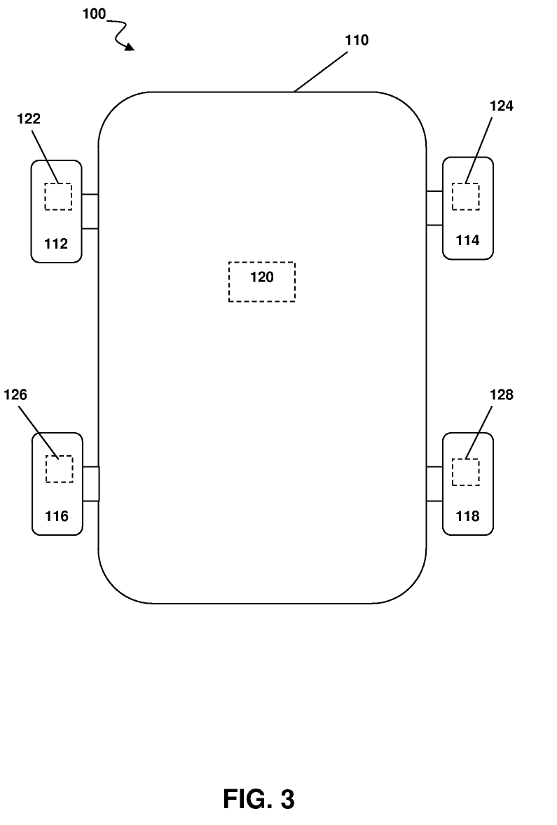

In another embodiment depicted in FIG. 3, vehicle GPS system 129 is omitted. ECU localizes each wheel 112-118 by comparing the positioning information received from each wheel module 122-128 with that received from the other wheel modules 122, 124, 126, and/or 128. In one embodiment, the position of each wheel 112-118 can be calculated when vehicle 110 is stationary or moving at a low rate of speed because wheel modules 122-128 may not be synchronized and may be operating only intermittently and with a relatively low duty cycle to conserve power. When vehicle 110 is moving at only a low rate of speed, time and velocity information can be used to extrapolate the positions of individual wheels 112-118.

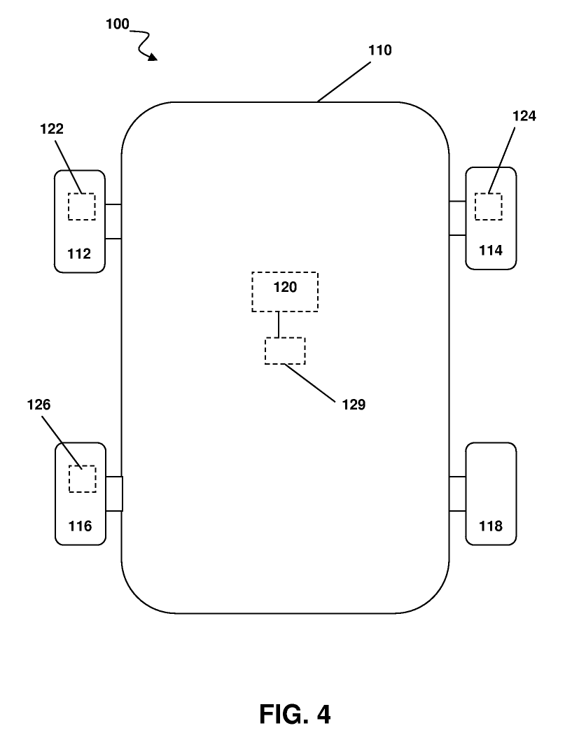

FIG. 4 depicts yet another embodiment of TLS 100. In this embodiment, only three wheels 112, 114, and 116 comprise wheel modules 122, 124, and 126. TLS 100 can further comprise vehicle GPS system 129. In this embodiment, ECU 120 can determine the relative position of wheel 118 (front or rear, right or left) from the positions of the other wheels 112, 114, and 116 having wheel modules. Omitting one wheel module (128) can reduce the cost and complexity of TLS 100 while still providing accurate full localization.

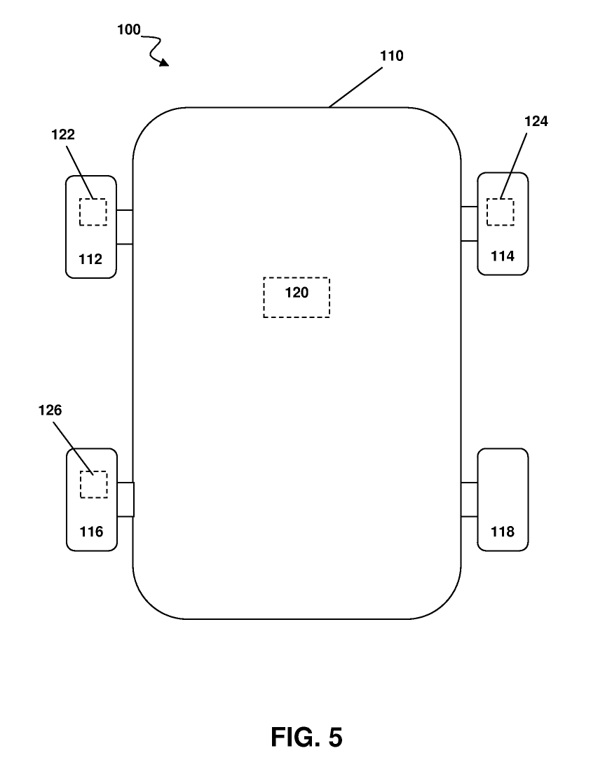

A further embodiment of TLS 100 is depicted in FIG. 5. Similar to the embodiment of FIG. 4, only three wheels 112, 114, and 116 comprise wheel modules 122, 124, and 126, and vehicle GPS system 129 is also omitted. Each wheel module 122-126 provides information by which each corresponding wheel 112-116 can be localized, and wheel 118 can be deduced by ECU 120 from the positions of the other wheels.

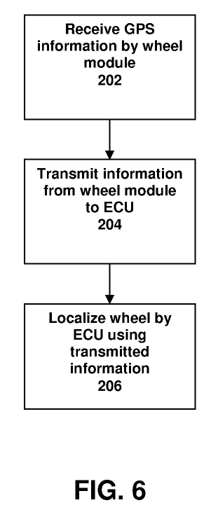

In operation, and referring to FIG. 6, each wheel module 122-128 (or wheel modules 122-126 in the embodiments of FIGS. 4 and 5) receives GPS information wirelessly by GPS receiver 138 at step 202. Step 202 may not be simultaneous among all wheel modules 122-128 given relatively low and unsynchronized duty cycles, intermittent operation, and other power-conserving techniques.

Information is wirelessly transmitted by each wheel module 122-128 (or wheel modules 122-126 in the embodiments of FIGS. 4 and 5) to ECU 120 at step 204. The information transmitted can comprise both GPS position-related information as well as data from sensor 132 and TPMS 130.

At step 206, ECU 120 calculates the position of, or localizes, each wheel 112-118 (or wheels 112-116 in the embodiments of FIGS. 4 and 5) based at least in part on the information transmitted in step 204. In the embodiments of FIGS. 1 and 4, the calculation can consider the relative position of each wheel module 112, 114, 116, and optionally 118 to vehicle GPS system 129. In these and other similar embodiments, ECU 120 can compare wheel module position to vehicle position at the same timestamp. In the embodiments of FIGS. 3 and 5, the calculation can be based on the relative positions of each of wheel module 112, 114, 116, and optionally 118, where vehicle GPS system 129 is omitted. In these and other similar embodiments, ECU 120 can use each wheel module position, speed, and timestamp information. As previously mentioned, this latter methodology may work best at or below a maximum vehicle speed which is related to the distance between wheels 112-118 and the time interval between updates of GPS information from wheel modules 122-128.

Embodiments of the invention can provide reliable, cost-effective, and full localization of vehicle wheels. Full localization in turn can provide more accurate and timely information to a driver or operator regarding the real-time status of a vehicle's tires or other systems, improving vehicle safety and reducing costs related to vehicle operation, less than ideal driving conditions, repairs exacerbated by undetected maintenance issues, fuel efficiency from under-inflated tires, and other issues.

Although specific embodiments have been illustrated and described herein for purposes of description of an example embodiment, it will be appreciated by those of ordinary skill in the art that a wide variety of alternate and/or equivalent implementations calculated to achieve the same purposes may be substituted for the specific embodiments shown and described without departing from the scope of the present invention. Those skilled in the art will readily appreciate that the invention may be implemented in a very wide variety of embodiments. This application is intended to cover any adaptations or variations of the various embodiments discussed herein, including the disclosure information in the attached appendices. Therefore, it is manifestly intended that this invention be limited only by the claims and the equivalents thereof.

1. A tire localization system comprising:
a wheel module comprising a sensor, a global positioning system (GPS) receiver, and a radio frequency (RF) transmitter; and
a control unit adapted to receive data from the sensor and the GPS receiver via the RF transmitter and determine a location of the wheel module relative to the control unit from at least a portion of the data.

2. The tire localization system of claim 1, further comprising a plurality of wheel modules, each associated with a tire of a vehicle.

3. The tire localization system of claim 1, wherein the control unit comprises a GPS receiver.

4. The tire localization system of claim 1, wherein the sensor comprises an acceleration sensor included in a tire pressure monitoring system.

5. The tire localization system of claim 4, wherein the tire pressure monitoring system further comprises a microcontroller and a transmitter.

6. The tire localization system of claim 1, wherein the location of the wheel comprises a driver side or passenger side position of the wheel module.

7. The tire localization system of claim 6, wherein the location of the wheel further comprises a front or rear position of the wheel module.

8. A monitoring system associated with a tire of a vehicle, the monitoring system comprising:
a positioning system receiver adapted to wirelessly receive positioning information from a satellite-based system; and
a transmitter adapted to transmit the positioning information to a location in the vehicle external to the tire to enable localization of the tire relative to the vehicle.

9. The monitoring system of claim 8, further comprising a sensor adapted to detect data related to the tire.

10. The monitoring system of claim 9, wherein the transmitter is further adapted to transmit the data.

11. The monitoring system of claim 8, wherein the location comprises a vehicle-based electronic control unit.

12. The monitoring system of claim 11, wherein the electronic control unit comprises a receiver adapted to wirelessly receive positioning information from a satellite-based system.

13. The monitoring system of claim 12, wherein the satellite-based system comprises one of a global positioning system (GPS), GLONASS, and Galileo.

14. The monitoring system of claim 8, wherein the vehicle comprises four tires, and wherein a monitoring system is associated with at least three of the tires.

15. A method of localizing tires of a vehicle comprising the steps of:
receiving satellite-based system positioning information at a receiver in each of a plurality of vehicle tires;
transmitting the positioning information from a transmitter in each of the plurality of tires to a control unit in the vehicle; and
localizing each of the plurality of tires using the positioning information.

16. The method of claim 15, wherein the step of localizing further comprises localizing each of the plurality of tires relative to the control unit using the positioning information.

17. The method of claim 15, wherein the step of localizing further comprises localizing each of the plurality of tires relative to the other tires.

18. The method of claim 15, wherein the step of receiving further comprises receiving one of global positioning system (GPS), GLONASS, and Galileo positioning information.

19. The method of claim 15, wherein the step of localizing further comprises determining both a front or rear and driver or passenger position of each of the plurality of tires.

20. The method of claim 15, further comprising the step of providing real-time status information related to at least one of the localized tires.
